(19) United States
(12) Patent Application Publication
(10) Pub. No.: US 2006/0160241 A1
(43) Pub. Date: Jul. 20, 2006

(54) Dual-luminophor compositions and related methods

(76) Inventors: Gamal-Eddin Khalil, Redmond, WA (US); Martin P. Gouterman, Seattle, WA (US); Colin D. Costin, Maple Grove, MN (US); James B. Callis, Seattle, WA (US); Sang Hyuk Im, Pohang (KR); Younan Xia, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/134,080

(22) Filed: May 19, 2005

Related U.S. Application Data
(60) Provisional application No. 60/632,932, filed on Dec. 3, 2004.

(51) Int. Cl. G01N 21/64

(52) U.S. Cl. 436/166; 436/172

(57) ABSTRACT

A dual-luminophor compositions that include a first luminescent compound having a luminescent emission that is sensitive to oxygen concentration, a second luminescent compound having a luminescent emission that is insensitive to oxygen concentration, and an oxygen-permeable host material; and method for measuring the pressure of an oxygen-containing fluid using the dual-luminophor composition.

### CROSS-REFERENCE TO RELATED APPLICATION

This application claims the benefit of U.S. Provisional Application No. 60/632,932, filed Dec. 3, 2004, incorporated herein by reference in its entirety.

### STATEMENT OF GOVERNMENT LICENSE RIGHTS

This invention was made with government support under grants NAG2-1157 awarded by the NASA Ames Research Center, NAG3-2455 awarded by the NASA Glenn Research Center, and F49620-01-1-0364 awarded by the Air Force Office of Scientific Research. The government has certain rights in the invention.

### FIELD OF THE INVENTION

The present invention relates to a composition that includes a first luminescent compound having luminescent emission (phosphorescence) that is sensitive to oxygen concentration and that acts as an oxygen sensor, and a second luminescent compound having luminescent emission (fluorescence) that is independent of oxygen concentration and that acts as a reference sensor.

### BACKGROUND OF THE INVENTION

Quantitative pressure measurements in a wind tunnel environment utilizing digital video imaging began in 1987. That system included a luminescent molecule incorporated into a paint matrix permeable to oxygen. The luminescence was quenched by oxygen and the quenching was determined to be pressure dependent through the Stern-Volmer equation. By calculating the ratio of intensities of a pressure-sensitive luminescent probe taken during wind-off and wind-on conditions, quantitative mapping of a continuous two-dimensional pressure field onto the aerodynamic surface was studied. However, there were several serious problems with the system, including photodegradation, response time, and temperature dependency. In addition, displacement of the model due to aerodynamic loading that commonly occurs during wind tunnel testing resulted in a mismatch of the wind-off and wind-on images. Errors resulting from model displacement can be partially resolved using image registration techniques to align the wind-off and wind-on. However, these techniques do not correct for the changes in illumination intensity that result from the model movement.

From initial studies of pressure-sensitive paint (PSP), it was clear that PSP accuracy requires temperature correction. More recently, some have stressed the importance of temperature correction for accuracy. Even with small pressure changes, temperature correction remains important.

The incorporation of a reference solid inorganic phosphor that is temperature and pressure insensitive to replace the wind-off (I_{wind-off}) image with a reference image (I_{ref}) of the luminescence phosphor has been investigated. In that system, difficulties arose from the inhomogeneous distribution of the phosphor solid. These difficulties led to inconsistencies in special uniformity of the intensity ratio I_{ref}/Iₛₑₙ and resulted in errors on the order of 30%.

The temperature of a model in a wind tunnel can vary over a wide range during a test. This temperature change results in changes in the intensity of the oxygen-sensing molecule, but leaves the solid reference intensity essentially unaffected. This error cannot be satisfactorily eliminated over the course of the wind tunnel testing.

In an attempt to eliminate these two problems, a system was developed in which a fluorescent reference having oxygen-independent luminescence and an oxygen-sensing molecule were homogeneously distributed in an oxygen-permeable film. This system also has a temperature dependence such that I_{ref}/Iₛₑₙ measures oxygen pressure with less temperature dependence than Iₛₑₙ alone. Indeed, use of this ratio reduced the temperature dependency to −0.3%/° C. However, for silicon octaethylporphine (Si(OEP)), the reference molecule employed in the system, the Q(0,0) emission band is more intense than Q(0,1) emission band and contains most of the fluorescent intensity. Because the Q(0,0) emission is reabsorbed, there is a film thickness dependence of the ratio I_{ref}/Iₛₑₙ for the ref/sen pair Si(OEP)/PtTFPL. A further problem with Si(OEP)/PtTFPL as a I_{ref}/Iₛₑₙ pair was that the longest wavelength emission Q(0,1) of Si(OEP) partly overlapped the shortest wavelength phosphorescence emission of the sensor PtTFPL, making it impossible to cleanly separate I_{ref} from Iₛₑₙ with filters.

Despite the advances made in the development of systems and reference/sensor pairs for determining oxygen pressure, a need exists for a system that compensates for temperature dependency; the sensor having minimal pressure dependence; the sensor and reference having photostability; the sensor and reference having similar solubility properties both in solvent and the polymer matrix; the sensor and reference having similar excitation bandwidths; and the sensor and reference having distinctly different emission wavelengths. The present invention seeks to fulfill these needs and provides further related advantages.

### SUMMARY OF THE INVENTION

In one aspect, the present invention provides a composition comprising (a) a first luminescent compound having a luminescent emission that is sensitive to oxygen concentration, the emission having a first emission wavelength band; (b) a second luminescent compound having a luminescent emission that is insensitive to oxygen concentration, the emission having a second emission wavelength band, wherein the first emission band and the second emission band have substantially no overlap; and (c) an oxygen-permeable host material.

In another aspect of the invention, a method for measuring the pressure of an oxygen-containing fluid is provided. In one embodiment of the method, an oxygen-containing fluid is flowed over a surface coated with a composition including a first luminescent compound, a second luminescent compound, and an oxygen-permeable host material, the a first luminescent compound having a luminescent emission that is sensitive to oxygen concentration, the emission having a first emission wavelength band, and the second luminescent compound having a luminescent emission that is insensitive to oxygen concentration, the emission having a second emission wavelength band, wherein the first emission band and the second emission band have substantially no overlap; at least a portion of the treated surface is irradiated with light having a wavelength sufficient to effect luminescent emission from the first and second luminescent compounds; and the luminescent emission intensity of the first and second luminescent compounds is measured. In another embodiment of the method, particles are flowed in an oxygen-containing fluid, the particles include a first luminescent compound, a second luminescent compound, and an oxygen-permeable host material, the a first luminescent compound having a luminescent emission that is sensitive to oxygen concentration, the emission having a first emission wavelength band, and the second luminescent compound having a luminescent emission that is insensitive to oxygen concentration, the emission having a second emission wavelength band, wherein the first emission band and the second emission band have substantially no overlap; at least a portion of the particles are irradiated with light having a wavelength sufficient to effect luminescent emission from the first and second luminescent compounds; and the luminescent emission intensity of the first and second luminescent compounds is measured.

In another aspect, the invention provides structures having surfaces to which have been applied a composition comprising (a) a first luminescent compound having a luminescent emission that is sensitive to oxygen concentration, the emission having a first emission wavelength band; (b) a second luminescent compound having a luminescent emission that is insensitive to oxygen concentration, the emission having a second emission wavelength band, wherein the first emission band and the second emission band have substantially no overlap; and (c) an oxygen-permeable host material.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of a device for measuring dual-luminophor emissions from a sample treated with a dual-luminophor composition in accordance with the method of the invention;

FIGS. 2A and 2B illustrate the absorption (2A) and emission (2B) spectra excited at 400 m of a representative reference/sensor pair (MgTFPP and PtTFPL), each taken separately; all spectra are at room temperature of acetone solutions; the PtTFPL emission is in 3-methylpentane at 77° K;

FIG. 3 illustrates the emission spectra of a representative dual-luminophor-containing film at several percentage oxygen concentrations, excited at 400 nm at room temperature;

FIG. 4 illustrates the raw signals of MgTFPP and PtTFPL as function of pressure at five different temperatures;

FIG. 5 illustrates pressure Stern-Volmer plots from raw signals for PtTFPL and MgTFPP in FIB at five different temperatures;

FIG. 6 illustrates ratio intensity plots of MgTFPP/PtTFPL as function of pressure at five different temperatures;

FIG. 7 illustrates pressure Stern-Volmer plots of the ratios at five different temperatures;

FIG. 8 illustrates temperature dependencies at 760 Torr of a representative dual-luminophor paint;

FIG. 9 illustrates the spatial uniformity of the dual paint, data shown is based on a single set of images using two CCD cameras, therefore, the ratio of ratios involves four images, the noise due to probe distribution, and thus the noise in the resulting pressure measurement;

FIG. 10A-10C are SEM images of representative polystyrene (PS) beads of the invention containing a representative dual-luminophor pair (SiOEP and PtOEP) that were synthesized with different AIBN concentrations (A, 6 mM; B, 12 mM; and C, 24 mM); FIG. 10D shows the correlation between the mean diameter of each sample and the concentration of AIBN;

FIGS. 11A and 11B are optical microscopy images of representative polystyrene beads (1.0 μm in diameter) that had been loaded with SiOEP and PtOEP: (A) dark field micrograph and (B) luminescence micrograph (images were taken from the same region of a sample at the same magnification, the arrow indicates a single PS bead);

FIG. 12 illustrates emission spectra recorded from representative polystyrene beads (1.0 μm in diameter) that contained SiOEP as reference and PtOEP as oxygen sensor (excitation at 400 nm and under pure nitrogen (0% oxygen) and air (21% oxygen), respectively);

FIG. 13A illustrates the oxygen sensitivity of representative polystyrene beads (1.0 μm in diameter) that were loaded with SiOEP and PtOEP, normalized emission intensities were measured at 580 nm for SiOEP and 650 nm for PtOEP; FIG. 13B is a plot showing the linear dependence between the intensity ratio of SiOEP to PtOEP and the concentration of oxygen; and

FIG. 14 is a comparison between the oxygen Stern-Volmer plots for representative polystyrene beads of two different sizes: 1.0 and 2.6 μm in diameter.

### DETAILED DESCRIPTION OF THE PREFERRED EMBODIMENT

In one aspect, the present invention provides a composition that includes (a) a first luminescent compound having a luminescent emission that is sensitive to oxygen concentration, the emission having a first emission wavelength band; (b) a second luminescent compound having a luminescent emission that is insensitive to oxygen concentration, the emission having a second emission wavelength band, wherein the first emission band and the second emission band have substantially no overlap; and (c) an oxygen-permeable host material.

The composition includes a first luminescent compound having luminescent emission (phosphorescence) that is sensitive to oxygen concentration (pressure) and that acts as an oxygen sensor. Suitable first luminescent compounds include compounds that have luminescent emission that is sensitive to oxygen concentration, have emission at a wavelength that can be measured and distinguished from emission from the second luminescent compound, and preferably can be excited at a wavelength that can also excite the second luminescent compound.

Representative first luminescent compounds include platinum porphyrin compounds including, for example, platinum tetra(pentafluorophenyl)porpholactone (PtTFPL) having absorbance maxima at 390 nm, 535 nm, and 575 nm, and an emission maximum at 740 nm; platinum tetrabenztetraphenyl porphine having absorbance maxima at 430 nm and 625 nm, and an emission maximum at 770 μm; platinum tetrabenzporphine having absorbance maxima at 430 nm and 600 nm, and an emission maximum at 750 nm; platinum tetra(heptafluoropropyl)porphine having absorbance maxima at 400 nm, 540 nm, and 565 nm, and an emission maximum at 730 nm; platinum tetra(pentafluorophenyl)porphine (Pt TFPP) having absorbance maxima at 390 nm, 506 nm, and 540 nm, and an emission maximum at 650 nm; and platinum octaethylporphyrin. Other suitable first luminescent compounds include palladium porphyrins including, for example, palladium tetra(pentafluorophenyl)porpholactone, palladium tetrabenztetraphenyl porphine, palladium tetrabenzporphine, palladium tetra(heptafluoropropyl)porphine, palladium tetra(pentafluorophenyl)porphine, and palladium octaethylporphyrin.

A comparison of the spectral and performance characteristics of two representative oxygen-sensitive platinum porphyrin compounds is presented in Table 1.

Table i. Comparison of spectral and performance properties of platinum tetra(pentafluorophenyl)porpholactone (PtTFPL) and platinum tetra(pentafluorophenyl)-porphine (Pt TFPP).

| Properties | PtTFPP | PtTFPL |
|---|---|---|
| Absorption bands nm (ε) | B(0, 0) 390(293), | B(0, 0) 396 (180), |
| | Q(1, 0) 506(19.1), | Q(1, 0) 536 (16.6), |
| | Q(0, 0) 540(25.4) | Q(0, 0) 574 (65.5) |
| Phosphorescence bands (nm) | T(0, 0) 650 | T(0, 0) 733 |
| | T(0, 1) 712 | T(0, 1) 810 |
| Phosphorescence yield (%) | 90 | 58 |
| Phosphorescence lifetime (μs) | 120 | 72 |
| Temperature coefficient | −0.6 | −0.24 |
| (% Intensity/° C.) | | |
| Drift (% Intensity/hour) | <1 | <1 |
| Sensitivity (% Intensity/torr) | ˜0.1 | ˜0.1 |

In addition to a luminescent compound having oxygen-sensitive emission, the composition includes a second luminescent compound having luminescent emission (fluorescence) that is independent of oxygen concentration (pressure) and that acts as a reference oxygen sensor. Suitable second luminescent compounds include compounds that have luminescent emission that is insensitive to oxygen concentration, have emission at a wavelength that can be measured and distinguished from emission from the first luminescent compound, and preferably can be excited at a wavelength that can also excite the first luminescent compound.

Representative second luminescent compounds include magnesium tetra(pentafluorophenyl)porphine (MgTFPP) having absorbance maxima at 420 nm, 558 nm, and 594 nm, and an emission maximum at 650 nm; yttrium tetra(heptafluoropropyl)porphine having absorbance maxima at 414 nm, 550 nm, and 586 nm, and an emission maximum at 646 nm; zinc tetra(pentafluorophenyl)porphine having absorbance maxima at 410 nm, 544 nm, and 594 nm, and an emission maximum at 640 nm; silicon octaethylporphine having absorbance maxima at 400 nm, 530 nm, and 570 nm, and emission maxima at 580 nm and 630 nm; magnesium tetra(pentafluorophenyl)porpholactone having absorbance maxima at 428 nm, 572 nm, and 616 nm, and an emission maximum at 620 nm; tetra(pentafluorophenyl)porpholactone (free base) having absorbance maxima at 416 mm, 512 nm, and 644 nm, and an emission maximum at 647 nm; and tetrabenzporphine (free base) having absorbance maxima at 410 nm, 440 nm, 610 nm, and 658 nm, and an emission maximum at 660 nm.

In one embodiment, the first and second luminescent compounds absorb light at common wavelengths. For these compounds, emission from each compound can be elicited by excitation at a common wavelength by a single excitation source. In one embodiment, the excitation wavelength is about 400 nm.

In one embodiment, the second luminescent compound has a relatively small extinction coefficient (absorbance) and therefore does not suffer significantly from “self-absorption” (i.e., loss of emission intensity due to overlap of the compound's emission and absorbance bands). Representative second luminescent compounds having relatively small extinction coefficients and that do not suffer significantly from self-absorption from include magnesium tetra(pentafluorophenyl)porphine and yttrium tetra(heptafluoropropyl)porphine. These luminescent compounds are preferred in compositions where self-absorption can cause problems in measuring second luminescent (i.e., reference) emission intensity. For example, while self-absorption is not a significant problem for the microsphere (particle) embodiments of the invention, self-absorption can be a problem for the film embodiments of the invention. For the film embodiments, self-absorption increases with increasing film thickness.

The first and second luminescent compounds have emission bands having substantially no overlap. As used herein, the term “substantially no overlap” refers to two emission bands (e.g., first and second luminescent compound emission bands) whose intensity can be separately measured without significant luminescent intensity from the first compound contributing to the luminescent intensity of the second compound. In one embodiment, the difference in emission maxima between the first and second luminescent compounds is at least about 90 nm. In one embodiment, the difference in emission maxima between the first and second luminescent compounds is at least about 75 nm. In one embodiment, the difference in emission maxima between the first and second luminescent compounds is at least about 60 nm. In one embodiment, the difference in emission maxima between the first and second luminescent compounds is at least about 45 nm. In one embodiment, the difference in emission maxima between the first and second luminescent compounds is at least about 30 nm.

For the composition having platinum tetra(pentafluorophenyl)porpholactone (PtTFPL) as the first luminescent compound and magnesium tetra(pentafluorophenyl)porphine (MgTFPP) as the second luminescent compound, the difference in emission maxima is about 90 nm.

The luminophor pair of platinum tetra(pentafluorophenyl)porpholactone (PtTFPL) and magnesium tetra(pentafluorophenyl)porphine (MgTFPP) offer advantages associated with chemical compatibility and temperature sensitivity reduction, as well as robust measurement.

MgTFPP and PtTFPL are chemically similar and can be dissolved in the same polymer producing a uniform paint layer; the two dyes have similar photostability performances.

The dual luminophors PtTFPL and MgTFPP in the FIB polymer produced ‘ideal’ PSP measurements with pressure sensitivity of 4.5% per psi and a temperature dependency of less than −0.1%/° C. The temperature dependency of the dual luminophor intensity ratio (I_{ref}/Iₛₑₙ) is substantially reduced compared with the use of I(PtTFPP) alone which has a temperature dependence in FIB of 0.60%/° C.

Intensity ratio measurement based on I_{ref}/Iₛₑₙ can compensate for illumination variation over the model. Ratiometric method of the two intensities will produce a more robust oxygen/pressure sensor whereby several problems that arise with simple intensity measurement are avoided, such as light source changes, index of refraction and optical geometry.

In the composition, the ratio of the first luminescent compound to the second luminescent compound can vary depending on the absorbance and emission properties of each luminescent compound. Suitable ratios include ratios sufficient to permit emission measurement from each of the luminescent compounds over the range of oxygen pressures of interest. In one embodiment, the ratio of the first luminescent compound to the second luminescent compound is from about 1:1 to about 5:1 (w/w). For the films of the invention, in one embodiment, the ratio of the first luminescent compound to the second luminescent compound is about 3:1 (w/w). For the microspheres of the invention, in one embodiment, the ratio of the first luminescent compound to the second luminescent compound is about 2:1 (w/w).

In addition to the first and second luminescent compounds, the composition includes an oxygen-permeable matrix or host material in which the first and second luminescent compounds are dispersed. In one embodiment, the first and second luminescent compounds are substantially uniformly dispersed in the oxygen-permeable matrix. Suitable oxygen-permeable matrices include materials in which the first and second luminescent compounds are soluble. Suitable oxygen-permeable matrices include materials have optical properties that are compatible with the first and second luminescent compounds. Suitable oxygen-permeable matrices include materials that permeable to oxygen, are substantially transparent at the excitation and emission bandwidths of the first and second luminescent compounds, and do not interfere with the excitation of or emission from the first and second luminescent compounds. Representative oxygen-permeable matrices include a random copolymer of heptafluoro-n-butyl methacrylate and hexafluoroisopropyl methacrylate (FIB) (ISSI, Dayton, Ohio), dimethylsiloxane-bisphenol A-polycarbonate block co-polymer (MAX) (General Electric LR 3320, New Jersey), poly(bisphenol A-carbonate) polymer (Aldrich Chemical Company, Milwaukee, Wis.), and polystyrene beads (PS) (Polysciences, Inc., Warrington, Pa.). Other suitable host materials include those described in U.S. Pat. No. 5,965,642, Acrylic and Fluoroacrylic Polymers for Oxygen Pressure Sensing and Pressure-Sensitive Paints Utilizing These Polymers, incorporated herein by reference in its entirety.

In one embodiment, the composition of the invention is a film in which the first and second luminescent compounds are dispersed substantially uniformly in an oxygen-permeable material. In one embodiment, the films of the invention have thicknesses in the range of from about 10 to about 100 micrometers.

In a related embodiment, the composition is a solution or suspension that includes the first and second luminescent compounds, oxygen-permeable material, and one or more solvents that allow for application of the composition to a surface to be studied. The one or more solvents evaporate from the surface treated with the composition to provide a surface coated with a film including the first and second luminescent compounds dispersed substantially uniformly in the oxygen-permeable material.

A method for making a representative film including the first and second luminescent compounds dispersed substantially uniformly in an oxygen-permeable material is described in Example 1.

In another embodiment, the composition of the invention is a particle in which the first and second luminescent compounds are dispersed substantially uniformly in an oxygen-permeable material. Suitable particles include microspheres (e.g., beads) formed by polymerization processes. Representative microspheres include polystyrene microspheres. In this embodiment, the polymeric material making up the microsphere is the oxygen-permeable material in which the first and second luminescent compounds are substantially uniformly dispersed.

A method for making representative microspheres that include first and second luminescent compounds is described in Example 2.

Microspheres including the first and second luminescent compounds can be prepared by dispersion polymerization methods. Alternatively, microspheres including the first and second luminescent compounds can be prepared by soaking the first and second luminescent compounds into the microspheres by using a suitable solvent.

The microspheres of the invention are useful for measuring oxygen pressure or concentration in flowing media (e.g., air or water) and in biological applications (e.g., cardiopulmonary physiology research and medical devices).

In another aspect of the invention, methods for measuring the pressure of an oxygen-containing fluid are provided.

In one embodiment of the method, an oxygen-containing fluid is flowed over a surface coated with a composition including a first luminescent compound, a second luminescent compound, and an oxygen-penneable host material (i.e., a film), the a first luminescent compound having a luminescent emission that is sensitive to oxygen concentration, the emission having a first emission wavelength band, and the second luminescent compound having a luminescent emission that is insensitive to oxygen concentration, the emission having a second emission wavelength band, wherein the first emission band and the second emission band have substantially no overlap; at least a portion of the coated surface (i.e., film) is irradiated with light having a wavelength sufficient to effect luminescent emission from the first and second luminescent compounds; and the luminescent emission intensity of the first and second luminescent compounds is measured.

In another embodiment of the method, particles are flowed in an oxygen-containing fluid, each particle includes a first luminescent compound, a second luminescent compound, and an oxygen-permeable host material, the a first luminescent compound having a luminescent emission that is sensitive to oxygen concentration, the emission having a first emission wavelength band, and the second luminescent compound having a luminescent emission that is insensitive to oxygen concentration, the emission having a second emission wavelength band, wherein the first emission band and the second emission band have substantially no overlap; at least a portion of the particles are irradiated with light having a wavelength sufficient to effect luminescent emission from the first and second luminescent compounds; and the luminescent emission intensity of the first and second luminescent compounds is measured.

In the methods, the first luminescent compound, upon irradiation with light at wavelength λₐ, produces luminescence having an emission maxima of λ_{A} with intensity I_{A} that is dependent on oxygen pressure, and the second luminescent compound, upon irradiation with light at wavelength λ_{b}, produces luminescence having an emission maxima of λ_{B} with intensity I_{B} that is independent of oxygen pressure. Intensity I_{A} has substantially no overlap with intensity I_{B}.

In one embodiment, the luminescent intensity measurement is made by lowing an oxygen-containing gas to flow over the surface, irradiating at least a portion of the surface with light at λₐ and λ_{b}, while the oxygen-containing gas is flowing over the irradiated surface, detecting I_{A} and I_{B} for a plurality of areas of the irradiated surface; and determining the ratios of I_{A}/I_{B} for the areas to provide an indication of the pressure of the gas on the surface.

In another aspect, the invention provide a method for visualizing flow of an oxygen-containing gas over a surface of an object. In the method, an oxygen-containing gas is flowed over an aerodynamic surface coated with an oxygen-permeable film. The film includes a first luminescent compound and a second luminescent compound, wherein the first luminescent compound, upon irradiation with light at wavelength λₐ, produces luminescence having an emission maxima of λ_{A} with intensity I_{A} that is dependent on oxygen pressure, wherein the second luminescent compound, upon irradiation with light at wavelength λ_{b}, produces luminescence having an emission maxima of λ_{B} with intensity I_{B} that is independent of oxygen pressure, and wherein intensity I_{A} has substantially no overlap with intensity I_{B}.

The flow of the oxygen-containing gas over the surface is visualized by irradiating at least a portion of the surface with light at λₐ and λ_{b}, and observing luminescence intensities I_{A} and I_{B} for a plurality of areas of the irradiated surface.

In another aspect, the invention provides structures having surfaces to which have been applied a composition comprising (a) a first luminescent compound having a luminescent emission that is sensitive to oxygen concentration, the emission having a first emission wavelength band; (b) a second luminescent compound having a luminescent emission that is insensitive to oxygen concentration, the emission having a second emission wavelength band, wherein the first emission band and the second emission band have substantially no overlap; and (c) an oxygen-permeable host material.

In one embodiment, the surface is an aerodynamic surface. Representative aerodynamic surfaces include an airfoil, rotor, propeller, fixed-wing, turbine blade, nacelle, aircraft, missile, or automobile.

As noted above, in one embodiment, the present invention provides a pressure-sensitive paint (PSP) and a method for using the pressure-sensitive paint to measure pressure on a surface to which the paint is applied. The application of the pressure-sensitive paint to a surface allows for quantitatively mapping a continuous two-dimensional pressure field on the surface.

Several spectroscopic methods for measuring oxygen concentration or pressure are available that provide an internal referencing. These methodologies are designed to correct for many problems that exist with intensity measurement. Internal reference methods avoid several problems that arise with intensity measurement such as light source changes, index of refraction, optical geometry variations and fluctuations in film thickness and dye concentration. The methodologies in most cases are designed for two molecular species, A and B, in the sensor and three distinct wavelengths of light are used: λ₁, λ₂, and λ₃. Two light configurations can be described. In the first configuration, two exciting wavelengths of light and one detecting wavelength are used and in another configuration, one exciting wavelength of light and two detecting wavelengths of light are used. In principle, three distinct relationships between the species A and B can be described producing six distinct internal referencing methods.

An example known as the yardstick method uses two emitting molecules A and B, such that A is affected by the variable X and B is not affected; thus B serves as a yardstick for A. In one configuration of this method A absorbs at λ₁ and emits at λ₂; B absorbs at λ₁ and emits at λ₃. In this case, we have λ₁^{ex}, λ₂^{em}, and λ₃^{em} monitoring intensities of the last two. Commonly, the ratio of I(λ₃^{em}) to I(λ₂^{em}) is used as measure of X. The use of a yardstick method in wind tunnel pressure measurements is described below.

The common approach when using an intensity-based pressure-sensitive paint in a wind tunnel for eliminating variations in illumination, as well as variations in concentration or paint layer thickness, involves taking the ratio of a wind-off image to that of a wind-on image. For an ideal PSP, the ratio can be reduced to:

$$\frac{I ( {P}_{0} , {T}_{0} )}{I ( P , T )} \approx \frac{f ( P , {P}_{0} )}{g ( T , {T}_{0} )} \qquad ( 1 )$$

Here P₀ and T₀ represent a reference pressure and temperature, the functions f(P, P₀) gives its pressure dependence in the form of a Stern-Volmer curves and g(T, T₀) gives the temperature dependence. In detail, these are defined as:

$$\begin{matrix}{f}_{T} ( P , {P}_{0} ) = \frac{I ( {P}_{0} , T )}{I ( P , T )} & ( 2 ) \\ {g}_{P} ( T , {T}_{0} ) = \frac{I ( P , T )}{I ( P , {T}_{0} )} & ( 3 )\end{matrix}$$

An ideal paint has the potential to solve major problems encountered in wind tunnel research through the use of a temperature-dependent reference luminophor whose temperature dependence would partially cancel the temperature dependence g(T, T₀). For example, the reference would eliminate the problem of model motion by replacing the wind-off over wind-on intensity ratio by:

$$\frac{I ( P , {T}_{0} )}{I ( P , T )} -> \frac{{I}_{ref} ( P , T )}{{I}_{sen} ( P , T )} = \frac{{I}_{ref} ( T )}{{I}_{sen} ( P , T )} \qquad ( 4 )$$

Using the definition from Eq. (1), Eq. (4) can be re-written as:

$$\frac{{I}_{ref} ( P , T )}{{I}_{sen} ( P , T )} = \frac{{I}_{ref} ( T )}{g ( T , {T}_{0} )} \frac{f ( P , {P}_{0} )}{I ( {P}_{0} , {T}_{0} )} \qquad ( 5 )$$

Assuming that I_{ref}(P, T)=I_{ref}(T), the reference intensity is independent of P. The function (I_{ref}(T)/g(T, T₀)) is constant and ideally approaches unity if the temperature dependency of the sensor and reference luminophors cancels each other. In principle, Eq. (5) provides a method of eliminating the wind-off measurement and reducing or canceling the temperature dependency.

A dual-luminophor referenced intensity system that measures pressure based on the ratio of (I_{ref}/Iₛₑₙ) is provided with MgTFPP as a reference that is unaffected by oxygen and has emission at 650 nm and PtTFPL that is sensitive to oxygen pressure with emission at 740 nm. The spectral separation of the two luminophors is sufficiently great such that emission from each can be measured by the selection of appropriate optical filters. The ratio of these emission intensities depends on pressure, with very low temperature dependence. MgTFPP and PtTFPL are chemically similar and can be dissolved in the same polymer producing a uniform paint layer. Use of the intensity ratio measurement based on I_{ref}/Iₛₑₙ can compensate for illumination variation over the model, and for some of the temperature sensitivity. Compared to other dual-luminophors formulations that use solid phosphors for a reference, this system shows no measurable angular sensitivity. The dual-luminophors PtTFPL and MgTFPP in the FIB polymer produced ‘ideal’ PSP measurements with pressure sensitivity of 4.5%/psi and a temperature dependency of less than −0.1%/° C. The temperature dependency of the dual-luminophor intensity ratio (I_{ref}/Iₛₑₙ) is substantially reduced compared with the use of I(PtTFPP) alone which has a temperature dependence in FIB of 0.60%/° C. Use of a ratiometric method of the two intensities provides a robust oxygen/pressure sensor whereby several problems (e.g., light source changes, index of refraction, and optical geometry) that arise with simple intensity measurement are avoided.

Pressure-sensitive paint (PSP) is playing an important role in aerodynamic testing. Its use provides a number of advantages over discrete pressure taps traditionally used on conventional wind tunnel models: (i) obtaining continuous quantitative pressure distributions over a surface; (ii) visualizing dynamic flow processes that measure areas not possible with conventional pressure taps (e.g., thin trailing edges); and (iii) real time modeling. The result is better integration of experimental and computational fluid dynamics leading to significant reductions in time for prototyping of new designs. The use of PSP relies on accurate measurement of changes in the paint's luminescent intensity as a function of pressure change, which in turn requires careful monitoring and placement of light sources and pre-calibration of the PSP covered surface in “wind-off” conditions. Paint inhomogeneity and inconsistent surface illumination require exact registration of the calibration ‘wind-off’ image with subsequent ‘wind-on’ images for intensity change calculations to be meaningful. Model motion between ‘wind-on’ and ‘wind-off’ images leads to systematic errors that are hard to quantify. A dual-luminophor paint containing both a sensor and a reference luminophor molecule alleviates these technical problems. The present invention provides a dual-luminophor PSP made from the oxygen-sensitive molecule platinum tetra(pentafluorophenyl)porpholactone (PtTFPL), which provides Iₛₑₙ, and magnesium tetra(pentafluorophenyl)porphine (MgTFPP), which provides I_{ref} as the pressure-independent reference. The ratio I_{ref}/Iₛₑₙ in the FIB polymer produced ideal PSP measurements with a temperature dependency of −0.1%/° C.

In addition to the paint embodiment described above, first and second luminescent compounds can also be incorporated into microspheres.

The synthesis of monodisperse polystyrene (PS) beads loaded with representative first and second luminescent compounds (PtOEP and SiOEP, respectively) using the dispersion polymerization method is described in Example 2. Because the number of primary particles precipitated from the reaction medium was dependent on the concentration of initiator, the sizes of these PS beads was readily varied from 0.5 to 2.6 μm by simply controlling the concentration of initiator. In one embodiment, the beads have a diameter in the range of from about 0.5 to about 10 micrometers. The dual luminophors exhibited similar absorption spectra, but two distinctive luminescent peaks: SiOEP at 580 nm; PtOEP at 650 nm. While the phosphorescence intensity of PtOEP displayed a strong dependence on the concentration of oxygen, the fluorescence of SiOEP had no response toward oxygen. A linear correlation was obtained when the luminescence intensity ratio between SiOEP at 580 nm and PtOEP at 650 nm was plotted against the concentration of oxygen. This linear dependence provides a simple, reliable, and self-referenced means to continuously monitor the concentration of oxygen.

Polystyrene microspheres can be readily synthesized in large quantities and are various methods are available for incorporating multiple dyes into them. The sensor (oxygen sensitive) and reference (oxygen insensitive) compounds can be incorporated into the microspheres beads using three methods.

In one method, the sensor compounds can be absorbed by the beads by injecting the compounds into an aqueous suspension of beads followed by heating and agitating the suspension.

In another method, the luminescent compounds are incorporated into the beads by emulsion polymerization. The first and second luminescent compounds can be incorporated either sequentially or simultaneously. In one embodiment, the reference compound can be incorporated during the formation of small particles (‘core’) followed by reinitiating polymerization synthesis with the sensor compound (‘shell’).

In a third method, hollow microspheres can be prepared and then filled with the first and second luminescent dyes and suitable monomer. Once incorporated, polymerization can be initiated.

Microspheres containing first and second luminescent compounds can be used in a variety of applications including, for example, the study of turbulence dynamics and lung physiology.

Many important technological problems require a clear understanding of complex turbulent phenomena where the three-dimensional flows undergo continuous, random changes in time. Interestingly, while turbulence plays an active and crucial role in almost all areas of interest to engineering, it is not understood well at a fundamental level. At present, most models are based on the assumption that the flow is homogeneous. However, most turbulent flows are inhomogeneous. Therefore, one of the greatest challenges in turbulence modeling is to obtain a model that is based on the physics of turbulent flow behavior. To do so requires detailed experimental interrogation of both the time dependent pressure and velocity fields simultaneously in a turbulent flow, in order to extract the behavior of the velocity-pressure-gradient tensor and the dissipation tensor. The microspheres of the invention are useful in turbulence dynamics methods.

The microspheres of the invention can be prepared having a size sufficiently small so as to be able to follow fluid flow accurately. These microspheres allow for the sensing velocity and oxygen pressure, and for the measurement of a pressure field in two dimensions permitting simultaneous image acquisition of velocity and pressure fields.

The microspheres of the invention are useful in real-time sensing of oxygen in the capillary networks of the alveoli. The time and space dependent concentration of oxygen in the serum and red blood cell (rbc) phases of blood as it travels through the capillary beds of the alveoli can be measured using the microspheres of the invention. For red blood cells, oxygen saturation of hemoglobin can be measured by dual wavelength imaging oximetry. For the serum phase, micron-size oxygen sensitive spheres of the invention can be used, which exploit the phosphorescence quenching principle. Imaging oximetry is capable of measuring the oxygen status of hemoglobin in red blood cells as the composition of inspired gas is varied in live animals. Polystyrene beads (one micron diameter) of the invention that include first and second luminescent compounds can be taken into the blood stream of live animals and their phosphorescence measured during transit of the alveolar capillary beds.

The following examples are provided for the purpose of illustrating, not limiting, the invention.

### EXAMPLES

### Example 1

### Preparation and Properties of a Representative Film Containing Dual-Luminophors

In this example, the preparation and properties of a representative film containing first (PtTFPL) and second (MgTFPP) luminescent compounds in an oxygen-permeable material is described.

Materials. Platinum tetra(pentafluorophenyl)porpholactone (PtTFPL) and Mg tetra(pentafluorophenyl)porphine (MgTFPP) were purchased from Frontier Scientific (Porphyrin Products) in Logan, Utah. MgTFPP was made by a standard porphyrin metallation procedure. PtTFPL was made by insertion of platinum into the tetra(pentafluorophenyl)porphine ring by standard methods (see Khalil, G. E., et al., J. Porphyrins Phthalocyanines 6:135-145, 2002. The FIB polymer was obtained from ISSI, Dayton, Ohio.

PSP (A). Three stock solutions were prepared prior to making sample MgTFPP and PtTFPL dual-luminophor paint. These included the following: (1) FIB Polymer in α,α,α-trifluorotoluene 99% [benzotrifluorid (TFT) by Acros Organics, New Jersey, USA; 5 mass % in 100 ml (5.95 g FIB in 100 ml TFT)]; (2) MgTFPP in FIB/TFT stock, 1:200 (m/m) in 25 ml (0.0074375 g MgTFPP into 25 ml FIB/TFT stock); and (3) PtTFPL in FIB/TFT stock, 1:200 (m/m) in 25 ml (0.0074375 g PtTFPL into 25 ml FIB/TFT stock).

Dual-luminophor MgTFPP and PtTFPL solutions were prepared from the above stock solutions by mixing 0.769 ml of PtTFPL/FIB-TFT stock solution with 0.2307 ml of MgTFPP/FIB-TFT stock solution for total volume of 1 ml. Thus, the solution as prepared above contained the ratio 10:3 parts PtTFPL:MgTFPP (w/w), which is similar to the molar ratio. The 10:3 ratio is based on the selection of excitation wavelength, in this case 400 nm. For example, the ratio of PtTFPL:MgTFPP would be greater at excitation wavelengths greater than 400 nm.

Thin films were prepared using a Single Wafer Spin Processor WS-400A-6NPP/LITE by Laurell Technologies Corporation (North Wales, Pa.). In making the thin films using the Single Wafer Spin Processor, approximately 100 microliters of each paint was pipetted onto an aluminum coupon surface (1 cm×1 cm), which is placed over the vacuum seal of the machine. The resulting films had thickness in the range of 10-50 micrometers. The films were annealed in an oven at 70° C.

PSP (B). The PSP mixture is made by dissolving 0.007 g of MgTFPP, 0.007 g of PtTFPL, and 0.7 g of FIB in 10 ml of Oxsol 2000 (TFT) solvent. An emulsion is generated by adding 0.1 g of TiO₂ to this mixture and sonicating for several minutes. The PSP mixture was sprayed directly onto a 25 mm×25 mm aluminum coupon using an air brush and the coupon was then annealed at 65° C. for 20 min prior to calibration.

Fluorescent measurement. All emission spectra were taken at 25° C. and 760 Torr with controlled, varying percentage of oxygen. A luminescence spectrometer LS-50 B from Perkin-Elmer was used to generate the emission spectra. For varying the percentage oxygen, a N₂/O₂ RO-28 Mixer by Tylan was utilized, while a Fast Oxygen Analyzer by Oxigraf gave the most accurate oxygen percentage flushing the sensor film while placed in the luminescence spectrometer. Emission spectra were taken at the following percentage oxygen flushing our sample: 0, 5, 10, 15, 20, 25, 30 and 106%. All emission spectra were taken by exciting at 400 nm wavelength, excitation slit width of 15 nm, emission slit width of 10 nm, 1000 nm/min scan time, and using a 400 nm band pass excitation filter. To eliminate second-order scattering a long wavelength cut-off filter was placed at the entrance of the detecting monochromator. The filter only passes light above 500 nm.

Oxygen/pressure sensitivity. Stern-Volmer plots are generated using a PMT survey apparatus that can measure intensity as function of pressure and temperature. It measures a single point, spatially averaged over about 1 cm² at constant temperature. This instrument has a sample chamber that is temperature and pressure controlled, it uses filtered light from a tungsten lamp to excite the molecule, and detects the filtered emission using a photomultiplier tube (PMT). The excitation light is filtered using a 390 nm band pass filter with a 20 nm width at half height and the emitted light was filtered using a 690 nm long wavelength cut-off filter. The instrument allows the operator to choose up to 50 pressure steps. The pressure is set to vacuum then to atmospheric for initial calibration. A computer controlled valve mechanism sets the desired pressure value.

Temperature sensitivit. The temperature slopes (δ In I(%)/δT)ₚ at constant pressures are determined using the PSA apparatus. Sample temperature is computer controlled using a thermoelectric module that can add or subtract heat and set temperature to the desired value. Temperature is measured by an integrated circuit with 0.1° C. resolution. Measurement is made from 5 to 45° C. in 5° C. increments.

Response time. Ninety percent response is measured using a pressure jump apparatus. The system has a time resolution of 10 ms and measure the 90% response time for a jump of 1 atm.

Drift (photodegradation). The PSA survey apparatus is used to measure the slope (δI(%)/δT)_{T,P}; at 1 atm and 25° C. The luminescence intensity is measured while a constant illumination intensity for a period of at least 1 h is applied on the film.

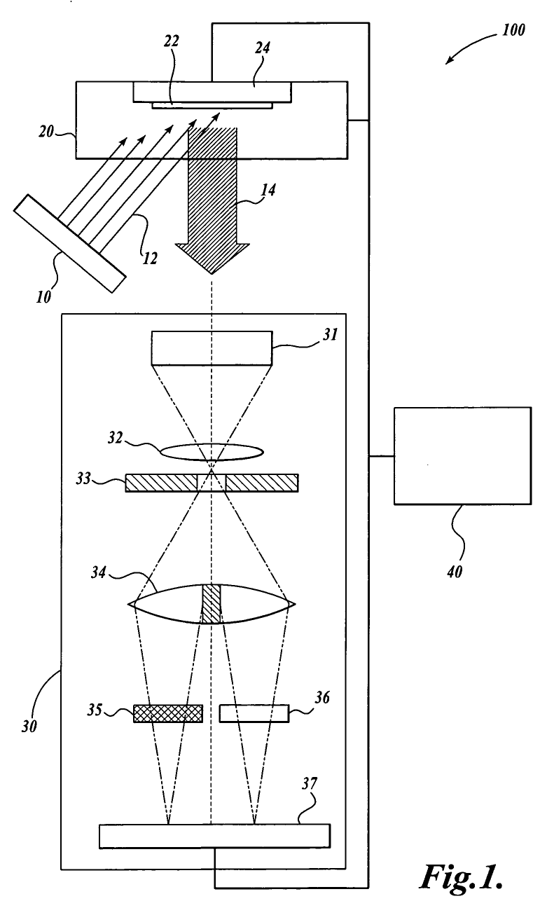

Intensity camera measurements. A representative instrument for evaluating the dual-luminophor pressure-sensitive paint is shown in FIG. 1. FIG. 1 illustrates the set-up for evaluation of a coupon painted with a representative PSP composition. It will be appreciated that the set-up can be used for evaluating the PSP composition applied to other surfaces. Referring to FIG. 1, an aluminum coupon 22 (4 cm×4 cm) is painted with the dual-luminophor pressure-sensitive paint to be calibrated and this coupon (or sample) is seated onto a Peltier thermo-electric cooler (24) and mounted inside the calibration chamber 20. The pressure inside the calibration chamber is controlled using a Ruska pressure controller (40) while the temperature of the sample is controlled using an Omega temperature controller (40). The sample is illuminated by array 10, an ISSI LM° 2 Lamp, which uses an array of 76 blue LEDs to produce excitation at 460±10 nm (12). The luminescence (14) from the sample is collected by Modified Multispec Imager (Optical Insights, LLC, Tucson, Ariz.) coupled to a CCD camera (Roper Scientific CCD Camera) (30). The optical train of the imager includes camera lens 31, which focuses collected light onto condensing lens 32, which passes the focused light through aperture 33 onto segmented objective lens 34, which segments and refocuses the light onto CCD chip 37. A first segment of the light (luminescence from the sensor probe, PtTFPL) passes through 650 nm filter 35 to CCD chip 37, and a second segment of the light (luminescence from the reference probe, MgTFPP) passes through 580 nm bandpass filter 36 to CCD chip 37. The CCD exposure timing is also controller by controller 40.

Recording the signal and reference images of the sample at 298° K and 14.696 psi begins the calibration; this serves as the reference condition. The temperature and pressure within the chamber are then varied over a range of temperatures between 5 and 50° C. (the temperature range over which the pressure probe and binder combination exhibits ideal behavior) and a range of pressures from 1 to 21 psi. Images from the sensor and reference cameras are recorded at each condition. The data is reduced using the ISSI OMS software package. First each signal and reference image is mapped onto a common grid. Next, the ratio of the sensor image to the reference image is computed at each temperature and pressure.

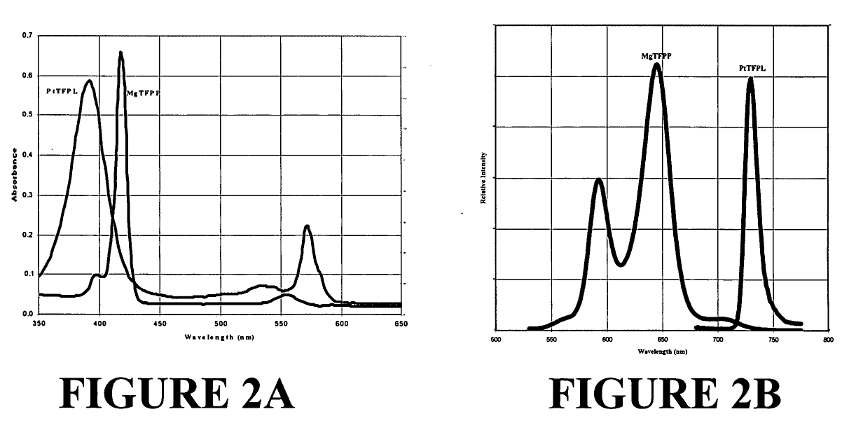

Absorption and emission spectra. FIGS. 2A and 2B shows the absorption spectra (2A) and emission spectra (2B) of the reference, MgTFPP, and the sensor, PtTFPL, taken separately. The MgTFPP main absorption peak is about 418 nm and the PtTFPL peak is at about 395 nm. While the two spectra do not closely overlap, there is a large spectral region about 400 nm where both molecules absorb strongly. It should be noted that the peak molar extinction coefficients are 367,000 M⁻¹ cm⁻¹ and 180,000 M⁻¹ cm⁻¹ for MgTFPP and PtTFPL, respectively. The very large energy gap between the main Q(1,0) absorption band of MgTFPP (λₑₓ about 552 nm) and its main emission Q(0,1) emission band (λₑₘ about 652 nm) shows that self-absorption is not a problem for this reference molecule. Previous experience showed that self-absorption of the reference luminophor produced sensor thickness dependency.

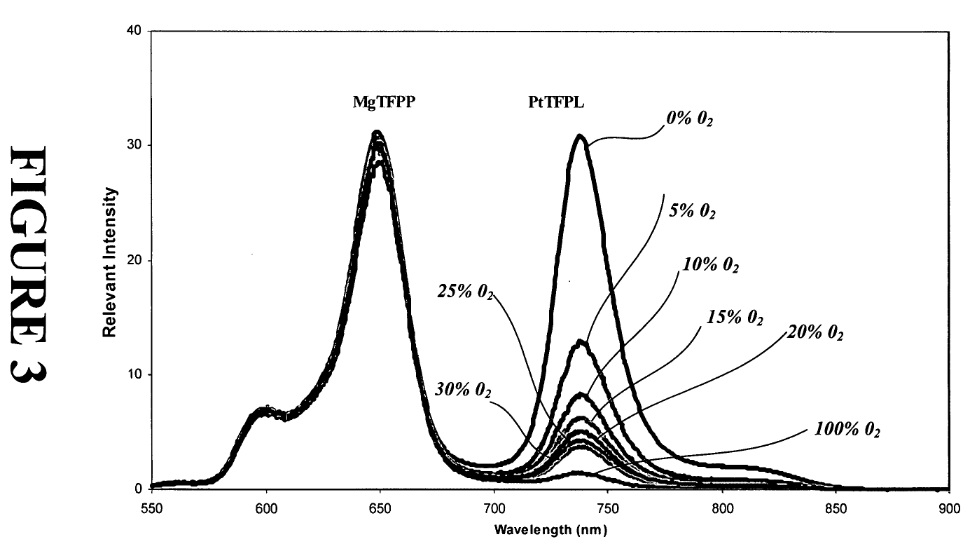

FIG. 3 shows the emission of the reference/sensor combination MgTFPP/PtTFPL in the polymer. The two emission bands are very well separated, and each can be easily detected using appropriate band pass filters. The emission spectrum of the sensor PtTFPL at about 740 nm is highly sensitive to the concentrations of oxygen, and the emission spectrum of MgTFPP reference sensor emission at 650 nm shows very little dependence on oxygen. Hence, the ratio of the fluorescence intensity at about 650 nm to the phosphorescence intensity at about740 nm is clearly pressure dependent as displayed in the corner plot in FIG. 3. These spectra are taken in FIB film at room temperature under different percentage oxygen concentrations (i.e., 0, 5, 10, 14, 20, 25, 30, and 100%).

Pressure and temperature measurement. Two independent studies were conducted: A and B. The data collected in B used two cameras system and the data collected in A used a PMT system, both described above. The two studies produced similar results and conclusions.

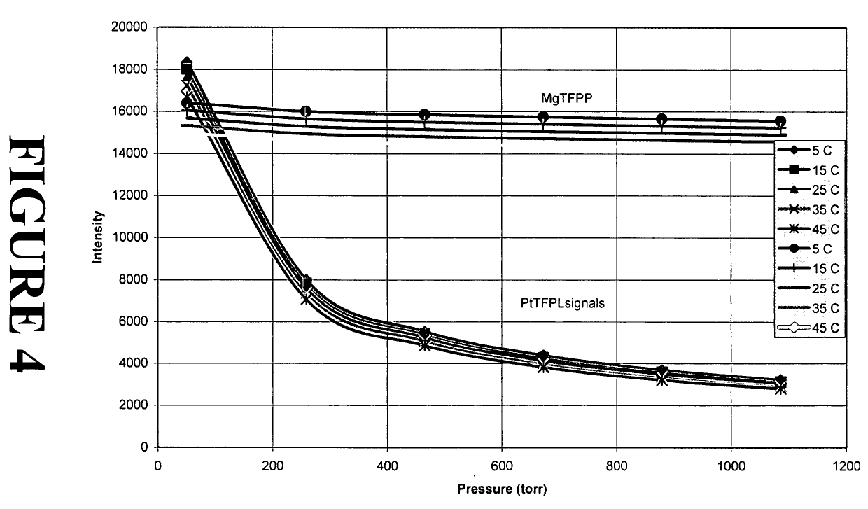

FIG. 4 shows the pressure dependence of intensity at five different temperatures (i.e., 5, 15, 25, 35, and 45° C.) for each luminophor in the dual sensor, monitoring each emission on a separate camera. Note that the emission intensity decreases at a specific pressure as temperature rises, as is expected for each sensor's temperature dependence. PtTFPL shows large decrease in intensity as the pressure is increased, as is appropriate for the primary pressure sensor; MgTFPP shows only small pressure dependence as expected for a reference. Similar data was obtained with a single camera fitted with MultiSpec Image device made by Optical Insights (Santa Fe, New Mexico). The device can produces two non-overlapping images on a single detector array. The images are produced simultaneously.

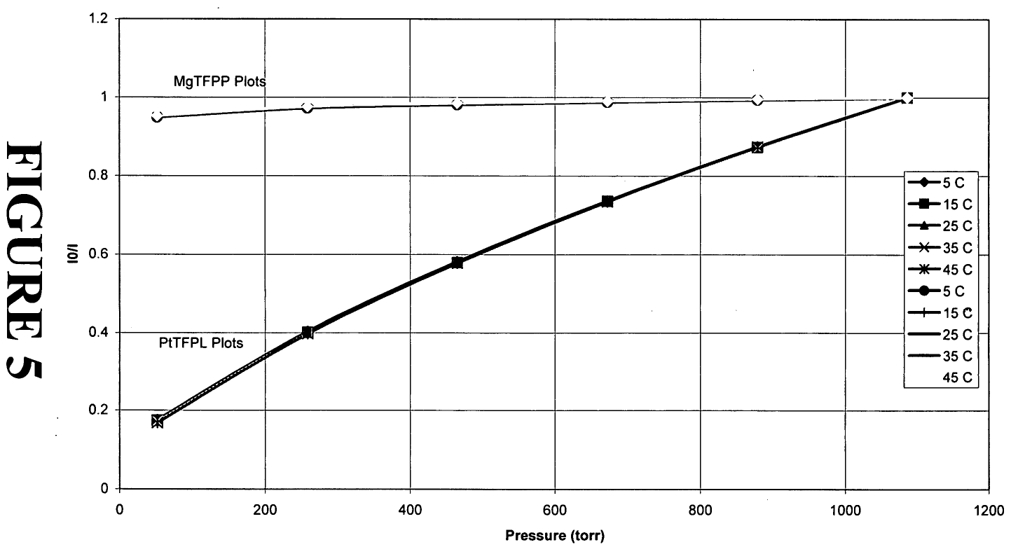

FIG. 5 shows the Stern-Volmer type plots of I₀/I versus pressure (Torr) for PtTFPL and MgTFPP in the FIB polymer. Note that here I₀ is the intensity at 21 psi (1086 Torr=1.44 atm). For the Stern-Volmer runs, the pressure drops from 21 to 1 psi. Six pressure runs are recorded at each temperature, and measurements are recorded at five temperatures between 5 and 45° C. (i.e., 5, 15, 25, 35, and 45° C.). Note that these pressure runs at five different temperatures overlay each other, which shows that this is an ideal paint: the pressure dependence is independent of temperature. The Stern-Volmer of the MgTFPP shows a nearly flat response to pressure while PtTFPL shows the typical PSP of 4.5%/psi. These paints were also studied by decay time. The MgTFPP reference has a lifetime of 8 ns at atmospheric pressure and has little change in lifetime with pressure. The lifetimes of PtTFPL in FIB were measured as function of pressure and temperature. The result shows a 65-7 μs range for vacuum to 1 atm pressure change and a temperature dependency of −0.023 μs/° C.

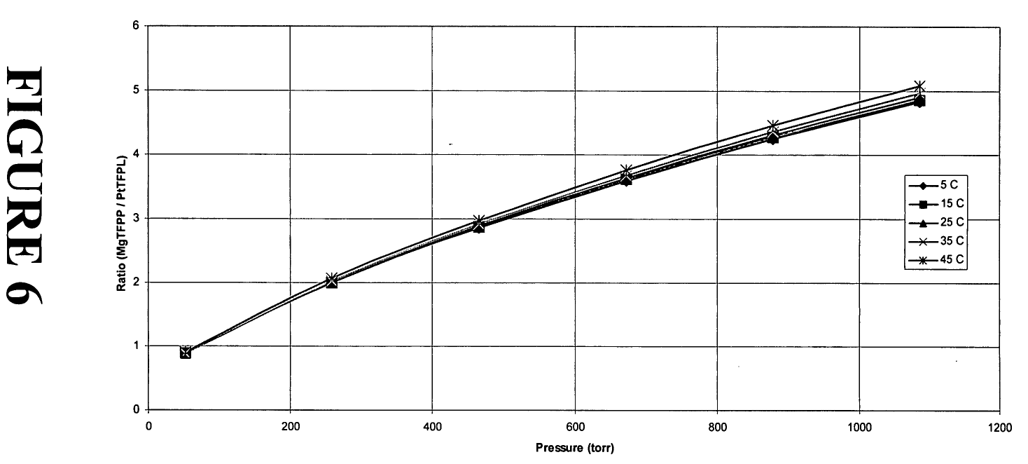

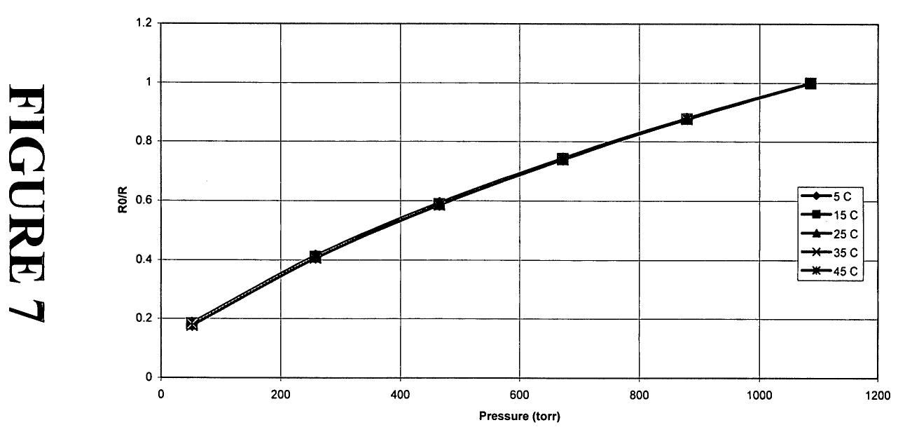

FIG. 6 shows the intensity ratio I_{ref}/Iₛₑₙ [I_{MgTFPP}/I_{PtTFPL}] as a function pressure at five different temperatures (i.e., 5, 15, 25, 35, and 45° C.). While ‘ideality’ requires that these pressure plots taken at different temperatures should be superposed, a slight dependence on temperature is observed. However, the degree of divergence in FIG. 6 type plots varies from run to run, and FIG. 6 represents a worst case. FIG. 7 shows the plot of the ratios at five different temperatures (i.e., 5, 15, 25, 35, and 45° C.) as function of pressure. This represents a plot of (I_{ref}/Iₛₑₙ)₀/(I_{ref}/Iₛₑₙ), which in effect normalizes FIG. 6 using the data points at the highest pressure for (I_{ref}/Iₛₑₙ)₀. The data points are superimposed.

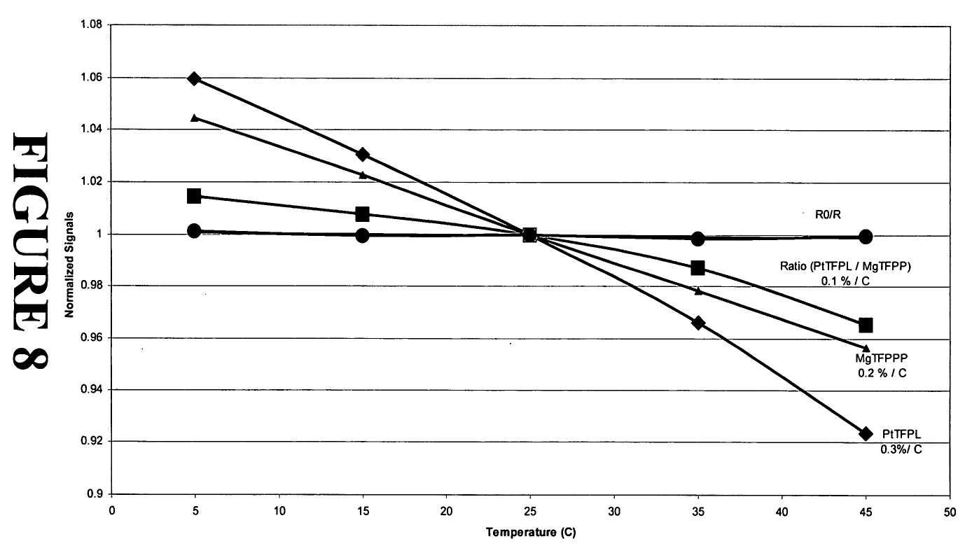

FIG. 8 is a plot of I(T)/I(25° C.) for PtTFPL, for MgTFPP, for the ratio I_{ref}/Iₛₑₙ, and also for the ‘ratio of ratios’ {(I_{ref}/Iₛₑₙ)₀/(I_{ref}/Iₛₑₙ)} as a function of temperature from 5 to 45° C. (i.e., 5, 15, 25, 35, and 45° C.). Thus, the temperature dependency of PtTFPL alone shows a range from 0.2 to −0.3%/° C. The temperature dependency of MgTFPP alone shows a range from 0.15 to −0.2%/° C. So that when a plot of the temperature dependence of the ratio (I_{ref}/Iₛₑₙ) is made, the slope is −0.1%/° C. or less. The dual sensor was irradiated continuously for 1 h, and power density of 1 mW/cm² at 25° C. and 1 atm. Both luminophors showed similar photodegradation of about 2%.

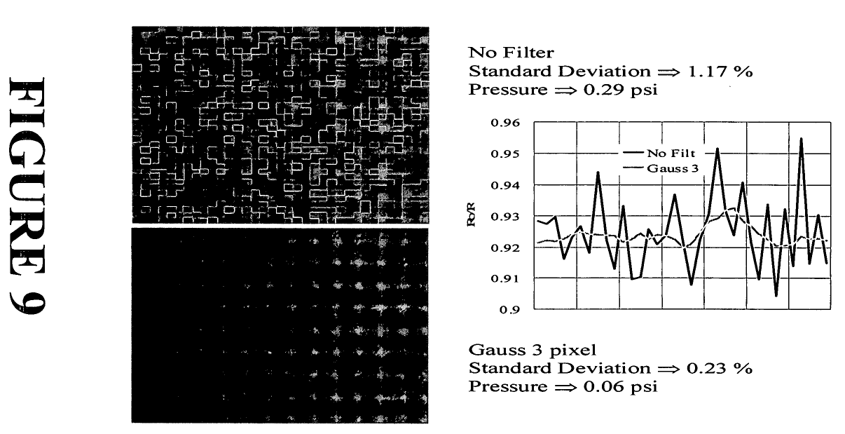

FIG. 9 shows the spatial uniformity of the dual paint. These data are based on a single set of images using two CCD cameras, so that the ratio of ratios involves four images. The raw images ratio measured at 1 atm and 25° C. has standard of deviation of 1.17%, which equates to 0.29 psi pressure error. The major parameters that may contribute to this noise level are camera shot noise, camera flat-field, image aligrnent, lamp stability, and probe ratio. The theoretical noise level that can be attributed to camera shot noise is about 0.5% and the ratio of ratios should eliminate the probe ratio as a source of noise therefore, the remaining noise is attributed to mapping errors and the absence of a flat-field correction for the two cameras. To further evaluate the potential resolution of this system, a data set was acquired using a single camera configuration and a filter switch. This experimental arrangement eliminates errors due to mapping and camera flat-field. To minimize shot noise fifty images of the sensor and reference probe were acquired and averaged. Each image was exposed to about 50% saturation and the camera has a 300,000 photon full well. The shot noise for these images was computed and found to be less than 0.1%. The experiment results showed that standard deviation of the ratio image is about 2.3% of the mean. This leads to the conclusion that the ratio of the probes varies by more than 2% over the surface of the coupon. The noise introduced by this variation in the probe ratio would be about 0.45 psi. Using a ratio of ratios reduces this noise to the camera shot noise level of less than 0.1% which is equal to 0.02 psi. Eliminating the noise due to this variation of probe distribution using the ratio of ratios while maintaining a minimum number of wind-off conditions requires that the paint calibration is uniform. This was verified in the calibration chamber by performing two calibrations. First, the paint was calibrated with the camera and lamp at near normal incidence to the paint sample. The second calibration was performed with the paint sample rotated by 30°. The data was reduced using a single reference condition at near normal incidence. The ratio of ratios data at common temperature and pressure, but at different angles, were compared and no measurable variation in this data is observed. This leads to the conclusion that the noise associated with variation in the distribution of the probes in the paint layer can be removed by applying the ratio of ratios approach using a single wind-off condition.

### Example 2

### Preparation of Representative Microspheres Containing Dual Luminophors

In this example, the preparation of polystyrene beads containing dual luminophors is described.

Synthesis of monodisperse polystyrene beads loaded with dual luminophors. In a typical synthesis, 45 mL ethanol and 5 mL deionized water (18 MQ) were placed in a three-neck flask (100 mL) equipped with a condenser. The solution was heated at 80° C. for 30 min and then 0.4 g poly(vinyl pyrrolidone) (PVP, molecular weight about 55,000, Aldrich, the steric stabilizer), 0.009 g silicon octaethylporphyrin (SiOEP) (Frontier Scientific), 0.031 g platinum octaethylporphyrin (PtOEP) (Frontier Scientific), 5 mL styrene (Aldrich, the monomer), and 0.1 g (12 mM) 2,2′-azobisisobutyronitrile (AIBN, Aldrich, the initiator) were sequentially added to the solution. The polymerization was allowed to proceed for 24 hours at 80° C. and magnetic stirring was applied during the entire synthesis. Finally, the suspension of polystyrene (PS) beads was cooled down to room temperature. The monodisperse polymer beads loaded with SiOEP and PtOEP were collected via centrifugation at 3,900 rpm for 2 min, followed by washing with ethanol three times. To vary the size of PS beads loaded with dual luminophors, the amount of AIBN was altered from 0.1 g to 0.05 g (6 mM) and 0.2 g (24 mM), respectively, while other conditions were maintained the same.

Characterization of polymer beads. Samples for SEM studies were prepared by dropping suspensions of the beads on a piece of silicon wafer, followed by drying in a fume hood. SEM images were taken using a field emission scanning electron microscope (FEI-SEM, Sirion XL) operated at an accelerating voltage of 5 kV. Optical micrographs of the PS beads were obtained using a Zeiss Axiovert 200 inverted microscope. The fluorescent images were captured with a Panasonic Industrial Color CCD camera (model number GP-KR222) by acquiring the luminescent light passing through a cutoff filter of 455 nm. The PS beads were excited by a 100-W mercury short arc lamp equipped a band pass filter centered at 405 nm and a line width of 40 run. The oxygen sensitivities of the PS beads were measured using a PMT-based survey apparatus. Both PtOEP and SiOEP were excited by the light passing through a band pass filter of 400 nm and the emission spectra were recorded from the light passing through a band pass filter of 650 nm for PtOEP and 580 nm for SiOEP, respectively. The samples were surrounded by a gaseous environment whose oxygen concentration was varied from 0 (pure nitrogen) to 21% (air).

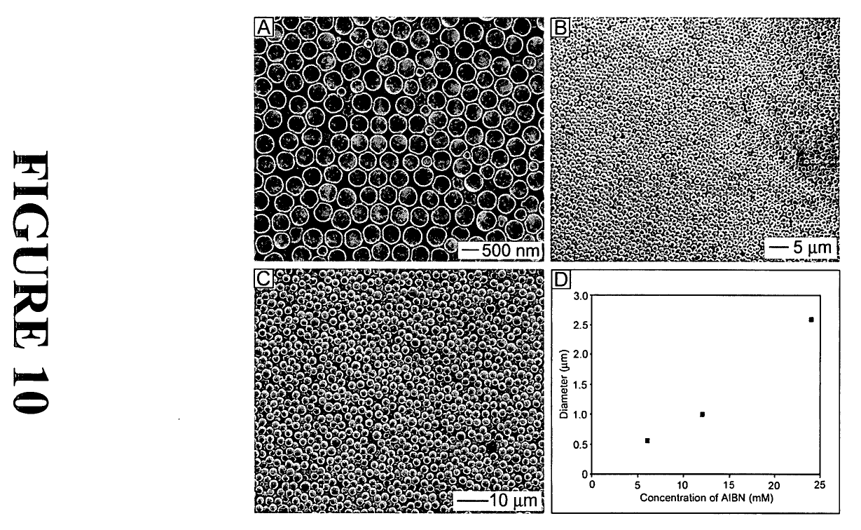

Results. For dispersion polymerization, the size of particles is strongly dependent on a number of parameters that include the concentration of initiator, steric stabilizer, or monomer; the polarity of reaction medium; and the polymerization temperature. Among all these parameters, it is most convenient and effective to control the size of particles by adjusting the concentration of initiator or steric stabilizer while maintaining the other variables. The size of PS beads loaded with dual luminophors was controlled by varying the concentration of AIBN exclusively. AIBN is an initiator added to the polymerization medium along with the monomer. FIG. 10A shows a typical SEM image of PS beads loaded with SiOEP and PtOEP, which were synthesized with 6 mM AIBN. This image indicates that the PS beads were mainly characterized by two different diameters: about 560 nm (the majority, >90%) and about 200 nm (<10%). The small particles could be easily separated from the sample through centrifugation. The small particles seem to originate from a second round of nucleation of the unreacted monomers due to the presence of initiator at a relatively low concentration. To alter the size of PS beads, the concentration of AIBN was increased from 6 to 12 and 24 mM and typical SEM images of these products are given in FIGS. 10B and 10C. These images clearly indicate that the diameters of resultant PS beads had increased to about 1 and about 2.6 μm, respectively. The dependence of particle size on the concentration of AIBN is plotted in FIG. 10D, indicating that the PS beads were monotonically enlarged as the concentration of initiator was increased. Without being bound to the any theory, the increase of initiator concentration may lead to the formation of more free radicals in the medium, which then results in shorter polymer chains that are more soluble in the polymerization medium. Because the number of insoluble, long chains was reduced, fewer primary particles were precipitated from the reaction medium and the precipitated particles grow larger sizes by consuming all of the monomers. As the PS bead became larger, their size distribution was also slightly broadened.

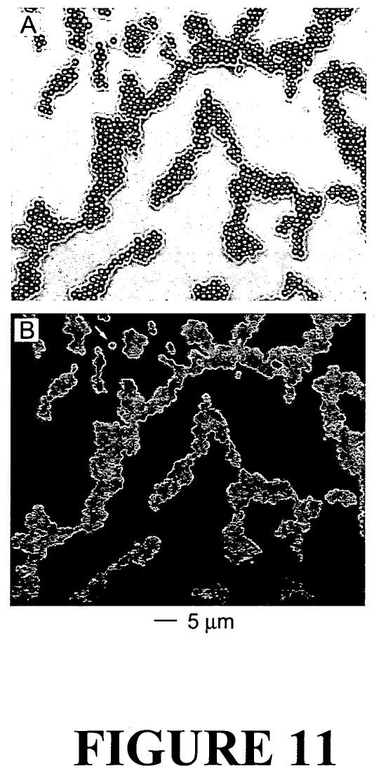

FIG. 11A shows a typical optical microscopy image of PS beads (1.0 μm in diameter) containing dual luminophors. These monodisperse particles readily assembled into a hexagonal lattice when their suspension was dropped on the surface of a glass substrate and dried under ambient conditions. FIG. 11B is a luminescence microscopy image clearly indicating the successful incorporation of luminophors into the PS beads. Because the luminescence emitted from the dual luminophors was so bright, it is difficult to distinguish adjacent particles in the hexagonally ordered array. It is believed that the dyes were well dispersed within the PS beads since the luminescence from each particle appeared to be homogeneous. The arrow indicates an individual PS bead that was emitting strong luminescence, implicating that the concentration of oxygen in a certain system can be determined by measuring the intensity of luminescence from a single particle.

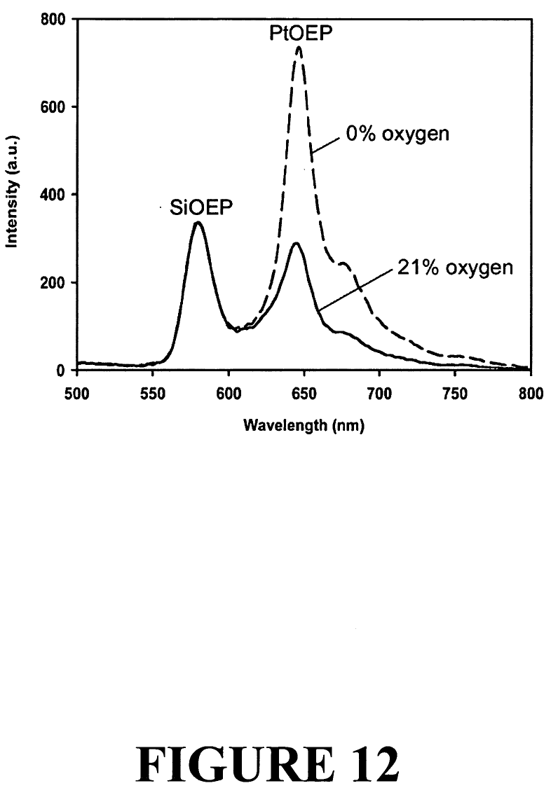

FIG. 12 shows the emission spectra recorded from PS beads (1.0 μm in diameter) that were loaded with SiOEP and PtOEP. Because the maximum absorption of PtOEP and SiOEP occurred around 400 nm, the sample was excited at this wavelength. It is clear that the emission peaks from these two dyes were distinctively separated and thus each emission can be resolved by introducing an appropriate band pass filter. The dashed curve shows the spectrum acquired under pure nitrogen. The emission peaks at 580 and 650 nm corresponded to fluorescence from SiOEP and phosphorescence from PtOEP, respectively. The difference in emission intensity was mainly determined by the molar ratio between SiOEP and PtOEP (1:3 for the present sample) incorporated into the PS beads. The solid curve shows the emission spectrum recorded from the same sample of PS beads under air (with 21% oxygen). Note that the intensity of emission peak at 580 nm from SiOEP was insensitive to the presence of oxygen while the intensity of emission at 650 nm from PtOEP was greatly quenched due to the presence of oxygen. This result implies that the concentration of oxygen can be simply measured by comparing the intensities of peaks emitted from PtOEP and SiOEP dyes loaded into the PS beads.

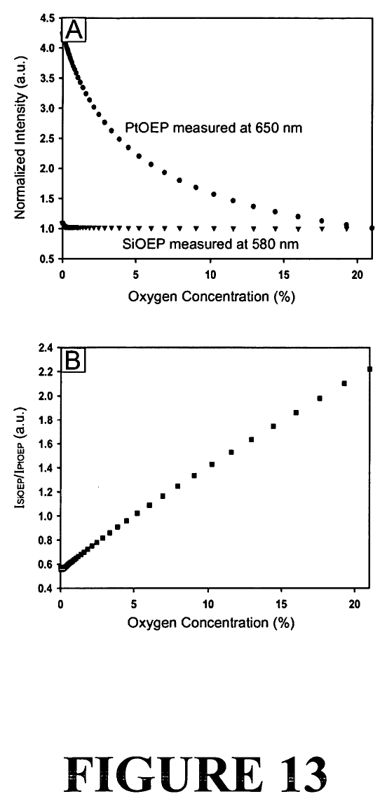

FIG. 13A shows how the luminescence intensity of each luminescent compound varied as a function of oxygen. As expected, the luminescence from SiOEP (at 580 nm) did not show any change in intensity as the concentration of oxygen was increased from 0 to 21%. In comparison, the intensity of luminescence from PtOEP (at 650 nm) was significantly reduced as the concentration of oxygen was increased (the intensity was inversely proportional to the concentration of oxygen). The intensity ratio of SiOEP to PtOEP (ISiOEP/IPtOEP) is plotted as function of oxygen concentration in FIG. 13B. The plot could be fitted to a linear relationship with an intercept of A=0.082, a slope of B=0.56, and a correlation coefficient of R²=0.998. Once A and B have been determined, the oxygen concentration can be readily derived from the measured intensity ratio (I_{SiOEP}/I_{PtOEP}).

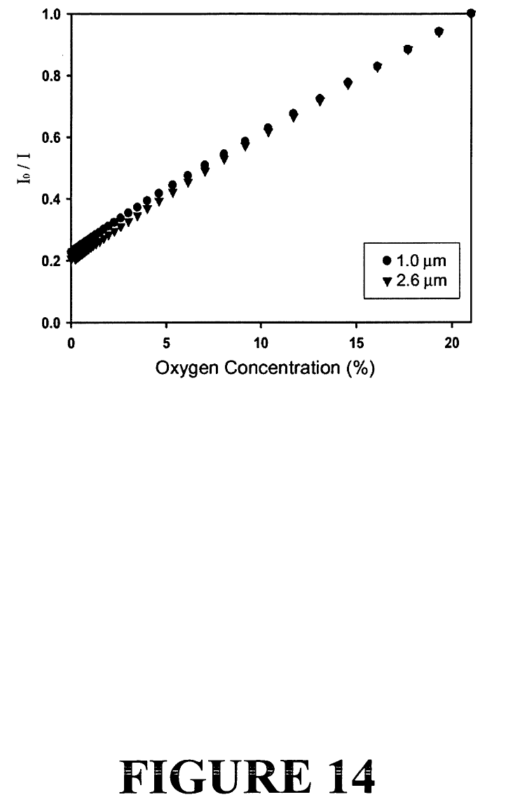

The influence of size of PS beads on their performance as oxygen sensors was evaluated. FIG. 14 compares the Kavandi-Stern-Volmer plots of I₀/I versus the concentration of oxygen for PS beads of two different sizes: 1.0 and 2.6 μm. Note that I₀ represents the intensity at 21% oxygen and the emission from PtOEP at 650 nm was measured as the percentage of oxygen was gradually reduced. It is worth emphasizing that the performance of PS beads of two different sizes was essentially the same. The slope for the 1.0- and 2.6-μm beads was 0.0373 and 0.0388, respectively, suggesting that the particle size had minor influence on the oxygen response. This result is not surprising because the PS beads are relatively small in size. These latex beads are also highly porous in structure so that oxygen molecules can easily diffuse into them to quench the luminophors at approximately the same rate.

While the preferred embodiment of the invention has been illustrated and described, it will be appreciated that various changes can be made therein without departing from the spirit and scope of the invention.

The embodiments of the invention in which an exclusive property or privilege is: claimed are defined as follows:

1. A composition, comprising:
(a) a first luminescent compound having a luminescent emission that is sensitive to oxygen concentration, the emission having a first emission wavelength band;
(b) a second luminescent compound having a luminescent emission that is insensitive to oxygen concentration, the emission having a second emission wavelength band, wherein the first emission band and the second emission band have substantially no overlap; and
(c) an oxygen-permeable host material.

2. The composition of claim 1, wherein the first luminescent compound is selected from the group consisting of platinum tetra(pentafluorophenyl)porpholactone, platinum octaethylporphine, platinum tetrabenztetraphenylporphine, platinum tetrabenzporphine, platinum tetra(heptafluoropropyl)porphine, and platinum tetra(pentafluorophenyl)porphine.

3. The composition of claim 1, wherein the second luminescent compound is magnesium tetra(pentafluorophenyl)porphine, yttrium tetra(heptafluoropropyl)porphine, zinc tetra(pentafluorophenyl)porphine, silicon octaethylporphine, magnesium tetra(pentafluorophenyl)porpholactone, tetra(pentafluorophenyl)porpholactone (free base), and tetrabenzporphine (free base).

4. The composition of claim 1, wherein the host material is poly(1H-1H-dihydroheptafluorobutylmethacrylate-co-1,1,1,3,3,3-hexafluoroisopropylmethacrylate).

5. A film, comprising:
(a) a first luminescent compound having a luminescent emission that is sensitive to oxygen concentration, the emission having a first emission wavelength band;
(b) a second luminescent compound having a luminescent emission that is insensitive to oxygen concentration, the emission having a second emission wavelength band, wherein the first emission band and the second emission band have substantially no overlap; and
(c) an oxygen-permeable host material.

6. The film of claim 5, wherein the first luminescent compound is selected from the group consisting of platinum tetra(pentafluorophenyl)porpholactone, platinum octaethylporphine, platinum tetrabenztetraphenylporphine, platinum tetrabenzporphine, platinum tetra(heptafluoropropyl)porphine, and platinum tetra(pentafluorophenyl)porphine.

7. The film of claim 5, wherein the second luminescent compound is magnesium tetra(pentafluorophenyl)porphine, yttrium tetra(heptafluoropropyl)porphine, zinc tetra(pentafluorophenyl)porphine, silicon octaethylporphine, magnesium tetra(pentafluorophenyl)porpholactone, tetra(pentafluorophenyl)porpholactone (free base), and tetrabenzporphine (free base).

8. The film of claim 5, wherein the host material is poly(1H-1H-dihydroheptafluorobutylmethacrylate-co-1,1,1,3,3,3-hexafluoroisopropylmethacrylate).

9. The film of claim 5 having a thickness of from about 10 to about 100 micrometers.

10. A method for measuring the pressure of an oxygen-containing fluid on a surface, comprising:
flowing an oxygen-containing fluid over a surface coated with a composition comprising:
(a) a first luminescent compound having a luminescent emission that is sensitive to oxygen concentration, the emission having a first emission wavelength band;
(b) a second luminescent compound having a luminescent emission that is insensitive to oxygen concentration, the emission having a second emission wavelength band, wherein the first emission band and the second emission band have substantially no overlap; and
(c) an oxygen-permeable host material;
irradiating at least a portion of the surface with light having a wavelength sufficient to effect luminescent emission from the first and second luminescent compounds; and
measuring the luminescent emission intensity of the first and second luminescent compounds.

11. The method of claim 10, wherein the surface is an aerodynamic surface.

12. The method of claim 10, wherein the surface is an airfoil, rotor, propeller, fixed-wing, turbine blade, nacelle, aircraft, or missile.

13. The method of claim 10, wherein the first luminescent compound is selected from the group consisting of platinum tetra(pentafluorophenyl)porpholactone, platinum octaethylporphine, platinum tetrabenztetraphenylporphine, platinum tetrabenzporphine, platinum tetra(heptafluoropropyl)porphine, and platinum tetra(pentafluorophenyl)porphine.

14. The method of claim 10, wherein the second luminescent compound is magnesium tetra(pentafluorophenyl)porphine, yttrium tetra(heptafluoropropyl)porphine, zinc tetra(pentafluorophenyl)porphine, silicon octaethylporphine, magnesium tetra(pentafluorophenyl)porpholactone, tetra(pentafluorophenyl)porpholactone (free base), and tetrabenzporphine (free base).

15. The method of claim 10, wherein the host material is poly(1H-1H-dihydroheptafluorobutylmethacrylate-co-1,1,1,3,3,3-hexafluoroisopropylmethacrylate).

16. A surface having a film thereon, the film comprising:
(a) a first luminescent compound having a luminescent emission that is sensitive to oxygen concentration, the emission having a first emission wavelength band;
(b) a second luminescent compound having a luminescent emission that is insensitive to oxygen concentration, the emission having a second emission wavelength band, wherein the first emission band and the second emission band have substantially no overlap; and
(c) an oxygen-permeable host material.

17. The surface of claim 16, wherein the first luminescent compound is selected from the group consisting of platinum tetra(pentafluorophenyl)porpholactone, platinum octaethylporphine, platinum tetrabenztetraphenylporphine, platinum tetrabenzporphine, platinum tetra(heptafluoropropyl)porphine, and platinum tetra(pentafluorophenyl)porphine.

18. The surface of claim 16, wherein the second luminescent compound is magnesium tetra(pentafluorophenyl)porphine, yttrium tetra(heptafluoropropyl)porphine, zinc tetra(pentafluorophenyl)porphine, silicon octaethylporphine, magnesium tetra(pentafluorophenyl)porpholactone, tetra(pentafluorophenyl)porpholactone (free base), and tetrabenzporphine (free base).

19. The surface of claim 16, wherein the host material is poly(1H-1H-dihydroheptafluorobutylmethacrylate-co-1,1,1,3,3,3-hexafluoroisopropylmethacrylate).

20. The surface of claim 16, wherein the film has a thickness of from about 10 to about 100 micrometers.

21. A microsphere, comprising:
(a) a first luminescent compound having a luminescent emission that is sensitive to oxygen concentration, the emission having a first emission wavelength band;
(b) a second luminescent compound having a luminescent emission that is insensitive to oxygen concentration, the emission having a second emission wavelength band, wherein the first emission band and the second emission band have substantially no overlap; and
(c) an oxygen-permeable host material.

22. The microsphere of claim 21, wherein the first luminescent compound is selected from the group consisting of platinum tetra(pentafluorophenyl)porpholactone, platinum octaethylporphine, platinum tetrabenztetraphenylporphine, platinum tetrabenzporphine, platinum tetra(heptafluoropropyl)porphine, and platinum tetra(pentafluorophenyl)porphine.

23. The microsphere of claim 21, wherein the second luminescent compound is magnesium tetra(pentafluorophenyl)porphine, yttrium tetra(heptafluoropropyl)porphine, zinc tetra(pentafluorophenyl)porphine, silicon octaethylporphine, magnesium tetra(pentafluorophenyl)porpholactone, tetra(pentafluorophenyl)porpholactone (free base), and tetrabenzporphine (free base).

24. The microsphere of claim 21, wherein the host material is polystyrene.

25. The microsphere of claim 21 having a diameter of from about 0.5 to about 10 micrometers.

26. A method for measuring the pressure of an oxygen-containing fluid, comprising:
flowing a plurality of particles in an oxygen-containing fluid, each particle comprising:
(a) a first luminescent compound having a luminescent emission that is sensitive to oxygen concentration, the emission having a first emission wavelength band;
(b) a second luminescent compound having a luminescent emission that is insensitive to oxygen concentration, the emission having a second emission wavelength band, wherein the first emission band and the second emission band have substantially no overlap; and
(c) an oxygen-permeable host material;
irradiating at least a portion of the particles with light having a wavelength sufficient to effect luminescent emission from the first and second luminescent compounds; and
measuring the luminescent emission intensity of the first and second luminescent compounds.

27. The method of claim 26, wherein the first luminescent compound is selected from the group consisting of platinum tetra(pentafluorophenyl)porpholactone, platinum octaethylporphine, platinum tetrabenztetraphenylporphine, platinum tetrabenzporphine, platinum tetra(heptafluoropropyl)porphine, and platinum tetra(pentafluorophenyl)porphine.

28. The method of claim 26, wherein the second luminescent compound is magnesium tetra(pentafluorophenyl)porphine, yttrium tetra(heptafluoropropyl)porphine, zinc tetra(pentafluorophenyl)porphine, silicon octaethylporphine, magnesium tetra(pentafluorophenyl)porpholactone, tetra(pentafluorophenyl)porpholactone (free base), and tetrabenzporphine (free base).

29. The method of claim 26, wherein the host material is polystyrene.
